(19) United States
(12) Patent Application Publication
(10) Pub. No.: US 2007/0011690 A1
(43) Pub. Date: Jan. 11, 2007

(54) Generic software interface architecture

(75) Inventor: Lionel Gilet, Austin, TX (US)

Correspondence Address: WAGNER, MURABITO & HAO, LLP, TWO NORTH MARKET STREET, THIRD FLOOR, SAN JOSE, CA, 95113, US

(73) Assignee: Credence Systems Corporation

(21) Appl. No.: 11/000,201

(22) Filed: Nov. 29, 2004

(51) Int. Cl. G06F 9/46

(52) U.S. Cl. 719/328

(57) ABSTRACT

A software interface for a system provides an interface to software components of the system through a plurality of interface areas that are related to each other in a hierarchical manner. Each interface area provides an interface to the software components through one or more interface methods. The interface methods are generically defined methods and include a data handling method, an action method, and a navigation method. The data handling method includes the methods for setting and retrieving a value of a parameter. The action method includes the methods for retrieving and executing a specific method for carrying out operations on the system through the software components. The navigation method includes methods for navigating to a specific interface area. A token is associated with each of the interface methods to specifically define the method that is to be carried out.

### BACKGROUND OF THE INVENTION

1. Field of the Invention

The present invention relates generally to a software interface and more particularly to a generic architecture for a software interface that is applicable to a variety of different software controlled systems.

2. Description of the Related Art

Application Programming Interfaces (APIs) are public interfaces to software products that are being published so that external clients, e.g., application programs, may interact with the software product. There are a lot of challenges when defining APIs because it is highly desirable that they be:
Simple from a syntax or prototype point of view;
Understandable and easy to use;
Limited in number so that a user can quickly find the API that he/she needs;
Stable over time so that the users do not have to update their client code each time the APIs change;
Flexible enough to guarantee forward compatibility;
Compatible with multiple languages; and
Implemented in a thin layer and capable of handling large data exchange with minimum overhead.

Some of the above requirements conflict with others making it very difficult to satisfy all of them. For example, having a small set of stable APIs is often incompatible with providing enough interfaces to satisfy the client's needs present and future.

### SUMMARY OF THE INVENTION

The present invention provides a generic architecture for a software interface, e.g., an API, that satisfies all of the above requirements so that it can be applied to any software product. The software interface of the present invention provides an interface to software components of a system that is operable under the control of software. The interface includes a plurality of interface areas related to each other in a hierarchical manner. Each interface area provides an interface to the software components through one or more interface methods.

The interface methods are generically defined methods and include a data handling method, an action method, and a navigation method. The data handling method includes the methods for setting and retrieving a value of a parameter. The action method includes the methods for executing a specific method for carrying out operations on the system through the software components. The navigation method includes methods for navigating to a specific interface area.

A token is associated with each of the interface methods to specifically define the method that is to be carried out. A token for the data handling method specifically identifies the parameter that is to be set or retrieved. A token for the action method specifically identifies the method that is to be executed. A token for the navigation method specifically identifies the destination interface area.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system controlled by software in which the present invention may be implemented;

FIG. 2 is a block diagram of a simplified API implemented in the system of FIG. 1;

FIG. 3 is a flow diagram illustrating the steps carried out by the system of FIG. 1 upon execution of an application program that is interfaced with the software components of the system of FIG. 1 through the API of FIG. 2; and

FIG. 4 is a flow diagram illustrating the steps carried out by the system of FIG. 1 upon execution of another application program that is interfaced with the software components of the system of FIG. 1 through the API of FIG. 2.

### DETAILED DESCRIPTION

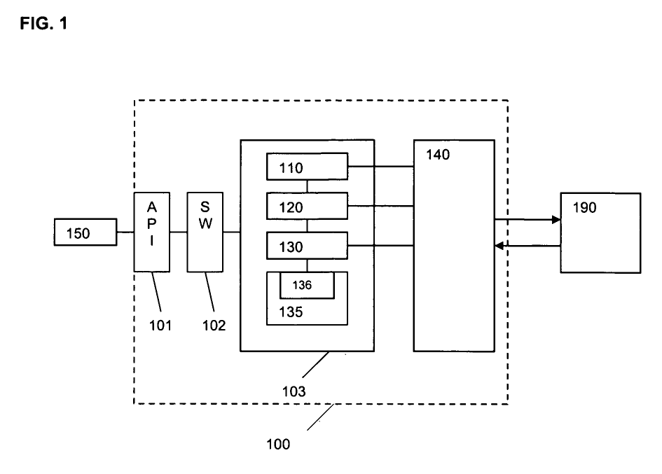

FIG. 1 is a block diagram of an electronic device test system in which the present invention may be implemented. The test system 100 includes a number of slots in which a number of test instruments are inserted. The instruments include a device power supply (DPS) 110 for supplying power to a device under test (DUT) 190, analog test instruments 120 for supplying test signals to input analog pins of the DUT 190 and receiving response signals from output analog pins of the DUT 190, digital test instruments 130 for supplying test signals to input digital pins of the DUT 190 and receiving response signals from output digital pins of the DUT 190, a test head interface 135 which houses a master clock 136, and a fixture 140, known in the art as a loadboard, for providing a connection interface between the instruments 110, 120, 130 and the DUT 190. During testing, the test system 100 operates under the control of software module 102. The software module 102 includes a plurality of software components that is interfaced to an application program 150 through an application programming interface (API) 101.

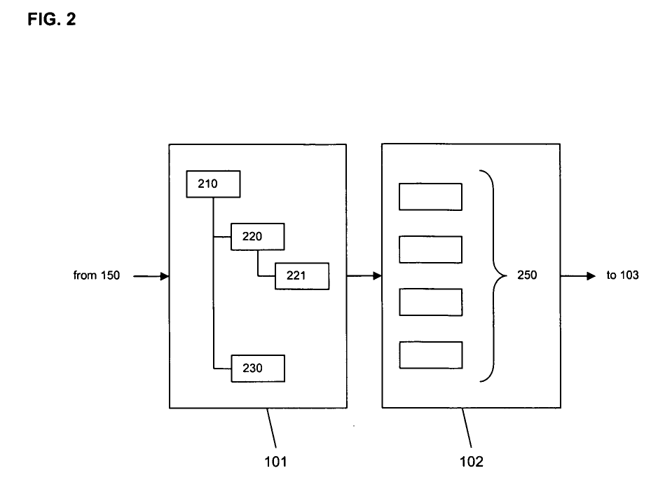

The API 101 and the software module 102 are illustrated in further detail in FIG. 2. The API 101 shown in FIG. 2 is a simplified API that includes a plurality of interface areas (210, 220, 221, 230) arranged in a hierarchical manner. In the preferred embodiment, these interface areas are implemented as software objects. Each of the interface areas is a software object that provides an interface to one or more software components 250 that control the operation of the test system 100 through one or more interface methods. The interface methods are generically defined methods and include a data handling method, an action method, and a navigation method.

The data handling method includes the methods for setting and retrieving a value of a parameter. The data handling methods have the following syntax:

data=area.getX(token); and

area.setX(token, data),

where area is an interface area; “token” is a key (e.g., a string) identifying the parameter that is being set or retrieved; “data” is the value of the parameter identified by the token; and “X” is a data type abbreviation, for example S for string, L for long, D for double, Sarray for string list, etc.

The action method includes the methods for retrieving and executing a specific method for carrying out operations on the system through the software components. The action methods have the following syntax:

area.invoke(token)

where area is an interface area; and “token” is a key that identifies the specific method that is to be carried out. The specific method that is to be carried out might require information that was specified using the setx method described above.

The navigation method includes methods for navigating to a specific interface area. The navigation method has the following syntax:

anotherArea=area.getArea(token)

where area is an interface area; “token” is a key that identifies the specific interface area to which navigation is desired; and anotherArea is the destination interface area. In some cases, an interface area may have several area objects, each of which is uniquely identifiable. A method such as, getNamedArea(token, id name), is a convenient shortcut for accessing one such area object. In the same way, when an interface area is a list of area objects, a method such as, next( ), can be used to iterate through the list.

Since the interface areas are organized hierarchically, it is possible to use shortcuts when navigating the interface areas. One possibility is to allow a token to be a combination of individual tokens. If the tokens are strings, for example, a separator (e.g., “.”) can be used to delimit different hierarchy levels. In that case, a token such as “human.body.skeleton.bone” can be used to get to a specific interface area (bone) without stepping through each level of the hierarchy. This approach may be extended to allow any level of the hierarchy to be a named area so that, by executing the method, “human.body.skeleton.cubitus.length,” the length of the “cubitus” bone can be obtained without navigating through the areas.

Each of the interface areas 210, 220, 221, 230 of the simplified API 102 has a name associated with it and a set of interface methods that are available to be used at the respective interface area. Table 1 provides the names of the interface areas, the interface methods that are available to each, and the tokens associated with each of the interface methods.

TABLE 1

| | | Interface | | |
|---|---|---|---|---|
| label | Name | Methods | Token | Description |
| 210 | CAP | getArea | ExecuteEngine | Navigate to |
| | | | | area |
| | | getArea | TestProgram | Navigate to |
| | | | | area |
| 220 | ExecuteEngine | getArea | ExecuteRegion | Navigate to |
| | | | | area |
| | | getL/setL | TimeOut | Test execution |
| | | | | time out |
| | | getS/setS | SyncName | Name of a |
| | | | | trigger |
| | | invoke | GenerateSync | Generate |
| | | | | trigger (name |
| | | | | previously set) |
| | | invoke | WaitForSync | Wait for trigger |
| | | | | (name and |
| | | | | timeout limit |
| | | | | previously set) |
| 221 | ExecuteRegion | getSarray | TimingDomains | List of time |
| | | | | domains names |
| 230 | TestProgram | gets/setS | FileName | File to load |
| | | invoke | Load | Load file |
| | | | | (name |
| | | | | previously set) |
| | | invoke | Unload | Unload file |
| | | | | (name |
| | | | | previously set) |

At the interface area 210, one interface method, getArea, is available. Using this method, navigation to either the ExecuteEngine interface area 220 or the TestProgram interface area 230 is possible. The following script illustrates how this is done:

exec=CAP.getArea(“ExecuteEngine”); or

tp=CAP.getArea(“TestProgram”).

From the interface area 220, another traversal down the hierarchy to the interface area 221 is possible using the command:

execsub=exec.getArea(“ExecuteRegion”).

It is also possible to directly navigate to the interface area 220 using the command:

execsub=CAP.getArea(“ExecuteEngine.ExecuteRegion”).

At the interface area 220, several data handling methods and the invoke method are available. The getL and setL methods are used to retrieve and set the test execution time out value in the parameter “TimeOut.” The getS and setS methods are used to retrieve and set the name of a synchronization trigger in the parameter “SyncName.” The invoke method is used in conjunction with either the “GenerateSync” token or the “WaitForSync” token. The invoke method used with the “GenerateSync” token generates the synchronization trigger identified in the parameter “SyncName.” The invoke method used with the “WaitForSync” token waits for the synchronization trigger identified in the parameter “SyncName” until a time out period specified in the parameter “TimeOut” is reached. The following script illustrates the usage of these methods:

exec=CAP.getArea(“ExecuteEngine”);

exec.setS(“SyncName”, “MyGenerateSync”);

exec.invoke(“GenerateSync”);

exec.setS(“SyncName”, “MyWaitForSync”);

exec.setL(“TimeOut”, maxTimeout);

exec.invoke(“WaitForSync”);

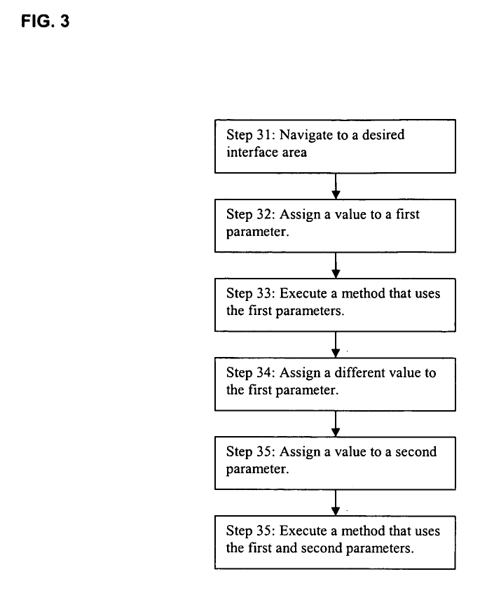

FIG. 3 is a flow diagram that illustrates the steps carried out by the software components of the system of FIG. 1 when the above script is executed. In Step 31, the ExecuteEngine interface area 220 is accessed from the CAP root interface area 210. In Step 32, the variable “SyncName” is set with the string value “MyGenerateSync.” In Step 33, the method identified by the “GenerateSync” token is executed. This method causes the system of FIG. 1 to generate the synchronization trigger having the name “MyGenerateSync.” In Step 34, the variable “SyncName” is set with the string value “MyWaitForSync” and in Step 35, the variable “TimeOut” is set with the test execution timeout value stored in maxTimeout. In Step 36, the method identified by the “WaitForSync” token is executed. This method causes the system of FIG. 1 to wait for the synchronization trigger having the name “MyWaitForSync” until the period set in the variable “TimeOut” has elapsed.

At the interface area 230, several data handling methods and the invoke method are available. The getS and setS methods are used to retrieve and set the name of a file in the parameter “FileName.” The invoke method is used in conjunction with either the “Load” token or the “Unload” token. The invoke method used with the “Load” token loads the file identified in the parameter “FileName” into memory. The invoke method used with the “Unload” token unloads the file identified in the parameter “FileName” from the memory. The following script illustrates the usage of these methods:

exec=CAP.getArea(“TestProgram”);

exec.setS(“FileName”, “MyTestFile”);

exec.invoke(“Load”);

exec.invoke(“Unload”);

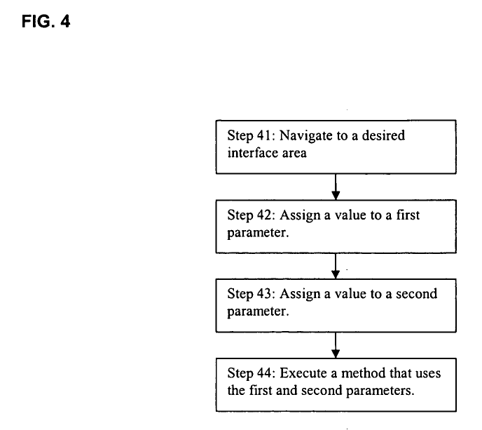

FIG. 4 is a flow diagram that illustrates the steps carried out by the software components of the system of FIG. 1 when the above script is executed. In Step 41, the TestProgram interface area 230 is accessed from the CAP root interface area 210. In Step 42, the variable “FileName” is set with the string value “MyTestFile.” In Step 43, the method identified by the “Load” token is executed. This method causes the system of FIG. 1 to load the file having the name “MyTestFile.” In Step 44, the method identified by the “Unload” token is executed. This method causes the system of FIG. 1 to unload the file having the name “MyTestFile.”

In order to perform some operations, a client (e.g., an application program) may have to make several successive calls to an area object. This has an impact on the area servant (i.e., the server resources assigned to the area object) because in a multi-threaded environment, the same servant could be called from different threads associated with different clients that would be passing different data. To address this need, a new servant object is created each time a getArea( ) or getNamedArea( ) is received. This allows servants to behave independently for different clients. The servants can collect data passed by the client, then perform an action generating new pieces of information and store them so that the client can retrieve them later on.

One side effect of this approach is that lots of servants will be created and at some point they must be disposed of. The hierarchical arrangement of the areas provides for a simple solution. Since an area servant is always obtained from another area servant and since area servants are client independent, it is very easy to establish a parent/child relationship between the area servants. A parent area servant would keep track of the child area servants that it has created through getArea( ) or getNamedArea( ) calls and a child area servant would remember the parent area servant that created it. This way a servant area when being destroyed can first destroy all of its child area servants and then tell its parent servant to disregard it.

On the client side, the above arrangement allows the client to define scopes in which it is getting and using area objects. The client enters the scope using an area object that is the entry point of the hierarchy of area objects. When the client is exiting the scope and does not need to keep the area objects any longer, it can simply tell the server to destroy (e.g., by using invoke (“Delete”)) the top parent area object that was used as the entry point and all the servants that were created during the scope execution would also be destroyed. If a client wants to use this scope destruction mechanism but also be able to hold onto a specific area object that has been created within the scope, a getArea(token) call can be used with a special token (e.g., “Clone”) that would bypass the default parent-child mechanism. The client is then responsible to ensure that the servant gets disposed of when appropriate.

The architecture described herein is conceptually very simple but its usability is directly dependent on how good and clear the software system's model and rules are. Indeed, the area hierarchy is a representation of the software system's model and the tokens and the order in which successive calls must be made to perform an operation are clearly related to the software system's rules. The challenge is not in the definition and maintenance of the interfaces anymore, but in the definition of the software system's model and rules and their representation using meaningful area and token names.

A significant advantage of this architecture is that new token and area names can be added using standard plug-in mechanism without impacting the interface itself. Since an area is always obtained from another one, it is possible to add a new area to the product using a registration mechanism, for example. As a result, the software system's model and rules can evolve and include new features without impacting the interface itself and with minimum impact on existing client's implementation.

A conventional software interface employs multiple software objects and each object has attributes and methods associated with only that particular object. To use each object, the application programmer needs to know the attributes and methods associated with that object, as well as the correct syntax for using that object. In situations where the software interface is relatively large and complex, this places an undesirable burden upon the application programmer to have knowledge of a large number of object methods and their syntax.

By contrast, in the software interface according to the present invention, the interface methods are not individually associated with the objects that make up the software interface areas. Instead, each interface method is capable of being used with different interface areas (i.e., area objects). Furthermore, each interface method is generic and is capable of being used with different software systems. Therefore, with the software interface according to the present invention, the knowledge burden placed upon the application programmer is greatly reduced.

Another example of a possible hierarchy of interface areas in the context of the electronic device test system is shown in Table 2. The area hierarchy is organized to relate the structure and functionality of the system components and software components of the test system. In the example, the root area is named electronicDeviceTester and has several areas below it in the hierarchy: testExecute, testProgram, and resultManager. The root area is the initial access point to the other interface areas. The areas below the root area divide the functionality of the software interface into logical groupings based on the architecture of the software module and the test system. The testExecute area provides access to software components that control the execution of tests on the test system. The testProgram area provides access to the details of the test being run by the test system. The resultManager area provides access to the results and to manipulation of the results of the test.

TABLE 2

| Area | Type of Area | Methods | Token |
|---|---|---|---|
| electronicDeviceTester | root | getArea( ) | testExecute |
| | | getArea( ) | testProgram |
| | | getArea( ) | resultManager |
| testExecute | below root | getL/setL | testTime |
| | | getS/setS | testName |
| | | invoke( ) | startTest |
| | | invoke( ) | waitTest |
| testProgram | below root | getS/setS | testActionName |
| | | getS/setS | testActionTime |
| resultManager | below root | getS/setS | resultName |
| | | invoke( ) | resultDisplay |

The root area, electronicDeviceTester, comprises three tokens for use with the interface method, getArea( ). The three tokens identify the areas that are below the root area: testExecute, testProgram, and resultManager.

The testExecute area comprises tokens for use with the getX/setX method, such as testTime and testName, and tokens for use with the invoke( ) method, such as startTest, and waitTest. The token testTime represents the time to start, or the duration of, a particular test. The token testName represents the identity of the test to be run. The invoke(“startTest”) method executes a sequence of program instructions that starts the execution of the test identified by the token testName. The invoke(“waitTest”) method suspends the test identified by the token testName.

The testProgram area comprises the testActionName token and the testActionTime token for use with the getX/setX method. The testActionName token identifies a particular action to be taken during a test, and testActionTime token identifies the duration of the test.

The resultManager area comprises the resultName token for use with the getX/setX method and the resultDisplay token for use with the invoke( ) method. The resultName token identifies a particular test result, and the invoke(“resultDisplay”) method executes a sequence of program instructions to display the particular test result stored in resultName on an output monitor.

The software interface according to the present invention is described above in the context of a test system. It is to be understood that the software interface according to the present invention may be used in a software-controlled system of any type.

While the foregoing is directed to embodiments of the present invention, other and further embodiments of the invention may be devised without departing from the basic scope thereof, and the scope thereof is determined by the claims that follow.

What is claimed is:

1. A system operable under the control of software, comprising:
a plurality of system components;
a plurality of software components that control the system components; and
a software interface having a plurality of interface areas related to each other in a hierarchical manner, each interface area providing an interface to the software components through one or more interface methods.

2. The system according to claim 1, wherein the interface methods include a first interface method specifically identified with a first token, and a second interface method specifically identified with a second token.

3. The system according to claim 2, wherein the first interface method provides an interface with software components that control a first system component, and the second interface method provides an interface with software components that control a second system component.

4. The system according to claim 3, wherein the interface methods further include a third interface method that is specified with a third token and an associated value, wherein the third token identifies a parameter that is to be set with the associated value.

5. The system according to claim 4, wherein the first interface method and the second interface method use the parameter identified by the third token.

6. The system according to claim 1, wherein the software interface is programmed to permit navigation from one interface area to another interface area through an interface method.

7. The system according to claim 6, wherein the interface method is specifically defined with a token.

8. The system according to claim 7, wherein the token identifies the name of said another interface area.

9. The system according to claim 1, wherein each interface method is a generically defined method and has associated therewith a token for specifically defining the method.

10. The system according to claim 9, wherein the generically defined interface methods include a data handling method, an action method, and a navigation method.

11. A method of communicating with software components of a system through interface areas related to each other in a hierarchical manner, comprising the steps of:
navigating to an interface area that is below the root level to access interface methods associated with said interface area; and
executing one of said interface methods to carry out operations on the system.

12. The method according to claim 11, further comprising the step of specifying a token, wherein the executed interface method corresponds to the interface method associated with the token.

13. The method according to claim 12, further comprising the step of specifying another token for use with another of said interface methods, wherein said another token identifies a parameter that is used by the interface method executed to carry out operations on the system.

14. The method according to claim 11, wherein the step of navigating includes the steps of navigating to an interface area that is at the root level and then navigating to the interface area that is below the root level.

15. The method according to claim 11, wherein the step of navigating includes the step of navigating directly to the interface area that is below the root level.

16. A method of communicating with software components of a system through interface areas related to each other in a hierarchical manner and through interface methods that work with the software components to carry out operations on the system, comprising the steps of:
(a) assigning a value to a parameter using a first one of the interface methods;
(b) specifying first and second tokens for a second one of the interface methods;
(c) executing a sequence of programmed instructions associated with the first token using the assigned parameter value; and
(d) executing a sequence of programmed instructions associated with the second token using the assigned parameter value.

17. The method according to claim 16, wherein the interface methods are generic to different types of systems.

18. The method according to claim 17, wherein the first and second tokens are specific to a particular type of system.

19. The method according to claim 16, further comprising the step of navigating to an interface area that is below the root level prior to carrying out steps (a) through (d).

20. The method according to claim 19, wherein the step of navigating includes the steps of navigating to an interface area that is at the root level and then navigating to the interface area that is below the root level.
